(19) United States
(12) Patent Application Publication
(10) Pub. No.: US 2026/0350968 A1
(43) Pub. Date: Nov. 5, 2026

(54) IDENTIFYING REPEATING PATTERNS

(71) Applicant: Adobe Inc., San Jose, CA (US)

(72) Inventors: Arthur Jules Martin Roullier, Paris (FR); Romain Pierre Rouffet, La Mulatiere (FR); Jerome Eric Christophe Derel, Hauts-de-Seine (FR); Adrien Michel Paul Kaiser, Lyon (FR); Elena Garces Garcia, Paris (FR)

(73) Assignee: Adobe Inc., San Jose, CA (US)

(21) Appl. No.: 19/195,451

(22) Filed: Apr. 30, 2025

(51) Int. Cl. G06V 10/77; G06V 10/56

(52) U.S. Cl. CPC G06V 10/7715; G06V 10/56

(57) ABSTRACT

In implementation of techniques for identifying repeating patterns, a computing device implements a pattern system to receive a digital image. The pattern system identifies a slice along a first axis of the digital image and a slice along a second axis of the digital image. The pattern system generates data describing pixel color along the slice along the first axis of the digital image and data describing pixel color along the slice along the second axis of the digital image. Based on the pixel color along the slice along the first axis and the pixel color along the slice along the second axis, the pattern system identifies a portion of the digital image depicting a visually repeating pattern.

### BACKGROUND

Patterns are repeated or recurring arrangements of elements, including shapes, colors, or textures. Various patterns are found in nature, art, mathematics, and digital images. Because patterns add visual interest to surfaces, incorporating patterns into various media is a common operation in a variety of disciplines, including graphic design, interior design, architecture, and game design. For example, patterns are desired for incorporation onto physical or virtual two-dimensional and three-dimensional surfaces. However, applying existing patterns to these surfaces presents technical difficulties in real world scenarios.

### SUMMARY

Techniques and systems for identifying sizes of repeating patterns are described. In an example, a pattern system receives a digital image.

The pattern system identifies a slice along a first axis of the digital image and a slice along a second axis of the digital image. In some examples, the pattern system identifies a two-dimensional autocorrelogram describing depicted texture variations on the digital image for identifying the slice along the first axis of the digital image and the slice along the second axis of the digital image.

Based on the slice along the first axis and the slice along the second axis, the pattern system generates data describing pixel color along the slice along the first axis of the digital image and data describing pixel color along the slice along the second axis of the digital image. For example, the data describing the pixel color along the slice along the first axis of the digital image and the data describing the pixel color along the slice along the second axis of the digital image includes a graph depicting peaks that correlate to sizes of repeating patterns in the digital image. In some examples, the pattern system generates a signal identifying maximum color contrast between pixels by performing a Fourier transform on the data describing the pixel color along the slice along the first axis of the digital image and the data describing the pixel color along the slice along the second axis of the digital image.

The pattern system then identifies a portion of the digital image depicting a visually repeating pattern based on the pixel color along the slice along the first axis and the pixel color along the slice along the second axis. For example, the pattern system identifies a height and a width of the portion of the digital image depicting the visually repeating pattern. In some examples, the pattern system applies the portion of the digital image depicting the visually repeating pattern to cover a three-dimensional virtual object.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for identifying repeating patterns as described herein.

FIG. 2 depicts a system in an example implementation showing operation of a pattern module for identifying repeating patterns.

FIG. 3 depicts an example of receiving an input including a digital image.

FIG. 4 depicts an example of identifying a horizontal slice of the digital image and a vertical slice of the digital image.

FIG. 5 depicts an example of identifying a size of a portion of the digital image depicting a repeating pattern based on pixel color along the horizontal slice of the digital image and pixel color along the vertical slice of the digital image.

FIG. 6 depicts an example of data from autocorrelograms corresponding to the horizontal slice of the digital image and the vertical slice of the digital image.

FIG. 7 depicts an example of outputs from identifying repeating patterns.

FIG. 8 depicts a procedure in an additional example implementation of identifying repeating patterns.

FIG. 9 depicts a procedure in an additional example implementation of identifying repeating patterns.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

Repeating patterns involve recurring arrangements of elements, including shapes, colors, or textures. A variety of repeating patterns, for instance, are found in nature, art, mathematics, and digital images. Because repeating patterns add visual interest to surfaces, incorporating repeating patterns into various media is a common operation in a variety of disciplines, including graphic design, interior design, architecture, and game design. For example, repeating patterns are desired for incorporation onto two-dimensional or three-dimensional surfaces that are physically or virtually represented. However, applying existing repeating patterns to these surfaces involves identifying repeating patterns in digital images, which is challenging. For instance, identifying where a repeating pattern begins and ends is difficult to determine.

Conventional repeating pattern identification techniques perform operations on multiple candidate sections of digital images and then iteratively fine-tune selections of the repeating pattern to identify segments that are capable of repeating. However, this is slow and uses a large amount of resources. This is because the conventional repeating pattern identification techniques utilize manual user contribution to fine-tune repeating pattern selections, for example, by cropping or shifting the selections of the repeating pattern.

Techniques and systems are described for identifying repeating patterns that overcome these limitations. For instance, color contrast is measured between pixels along horizontal and vertical slices of an autocorrelogram of a digital image to identify a size estimation value of portion of a repeating pattern in the digital image. This facilitates identifying a repeating pattern more quickly because size estimations are automatically made based on two slices of the autocorrelogram, rather than on multiple candidate sections of digital images. Additionally, the described techniques for identifying repeating patterns are automated and avoid manual user contribution involving fine-tuning selections of the repeating pattern.

A pattern system begins in this example by receiving an input including a digital image. At least a portion of the digital image, for instance, includes a repeating pattern, which is intended for extraction and application to another image or surface in this example. For example, the digital image depicts a weave of a basket that is desired to be extracted and applied in a repeated arrangement to cover a background.

To identify a size of the repeating pattern in the digital image, the pattern system generates an autocorrelogram based on the digital image. The autocorrelogram measures a correlation between a signal and a delayed copy of the signal, here applied to texture variations depicted on the digital image, which is conveyed by contrast of pixel color. Areas of the autocorrelogram with high contrast (e.g., dark pixels relative to light pixels) indicate repetition of texture depicted on the digital image.

The pattern system automatically extracts a horizontal slice and a vertical slice from the autocorrelogram. For instance, the horizontal slice is a central horizontal strip through the center of the autocorrelogram, and the vertical slice is central vertical strip through the center of the autocorrelogram. In other examples, the slices are extracted from another axis of the autocorrelogram, for instance, a first axis and a second axis.

The pattern system is configured to generate data indicating pixel values corresponding to the horizontal slice and data indicating pixel values corresponding to the vertical slice. In this example, the data indicating the pixel values involve frequency waves corresponding to levels of color contrast between pixels along the horizontal slice and pixels of the vertical slice. The pattern system identifies peaks in the data that indicate sizes of repeating patterns (i.e., where a repeating segment of a pattern begins and ends) in the horizontal and vertical directions. A position of a peak relative to the center, for instance, indicates a length of the repeating pattern, and a distance between vertical peaks indicates a height of the repeating pattern. The peaks are shifted or cropped in some examples to compensate for incomplete peaks, or repeating pattern segments that are cut off at the center of the autocorrelogram. Based on the peaks, the pattern system determines a size estimation value of the repeating pattern of the digital image.

In some examples, the pattern system also performs a Fourier transform to identify an additional size estimation value of the repeating pattern in the digital image based on the data indicating the pixel values corresponding to the horizontal slice and the data indicating pixel values corresponding to the vertical slice. The additional size estimation value, for instance, is based on a determination of a number of repetitions of the repeating pattern output from performing the Fourier transform on the autocorrelogram.

Based on the size estimation value and the additional size estimation value, the pattern system determines a size of the repeating pattern, for example based on selecting a larger value of the size estimation value or the additional size estimation value. The pattern system then generates an output indicating the size of a portion of the digital image that corresponds to the repeating pattern. In this example, the pattern system identifies a smaller portion of the digital image that depicts a repeatable segment of the basket weave pattern. For instance, the repeating pattern is then extracted or isolated from the digital image for incorporation into a different image or surface.

Identifying repeating patterns in this manner overcomes the limitations of conventional repeating pattern identification techniques that involve performing operations on multiple candidate sections of digital images and iteratively fine-tuning selections of the repeating pattern. For example, comparing color contrast between pixels along horizontal and vertical slices of an autocorrelogram of a digital image is performed to identify repeating patterns using two slices instead of multiple candidate sections. Additionally, selecting a larger size value from estimates produced separately based on an autocorrelogram and a Fourier transform reduces error. This is faster and uses fewer resources than the conventional repeating pattern identification editing techniques by avoiding performing operations on multiple candidate operations or fine-tuning selections of the repeating pattern.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

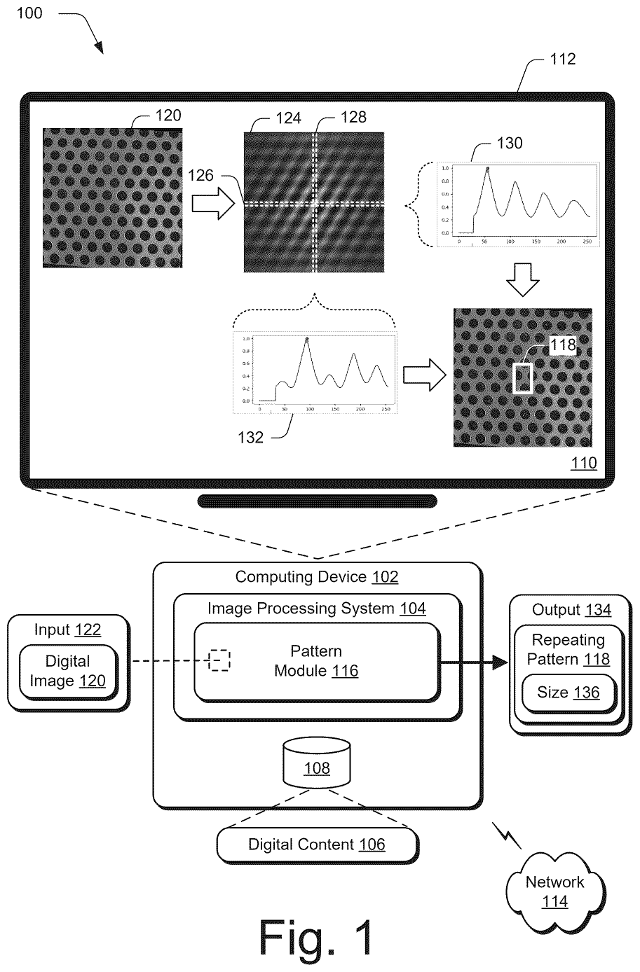

FIG. 1 is an illustration of a digital medium environment 100 in an example implementation that is operable to employ techniques and systems for identifying repeating patterns described herein. The illustrated digital medium environment 100 includes a computing device 102, which is configurable in a variety of ways.

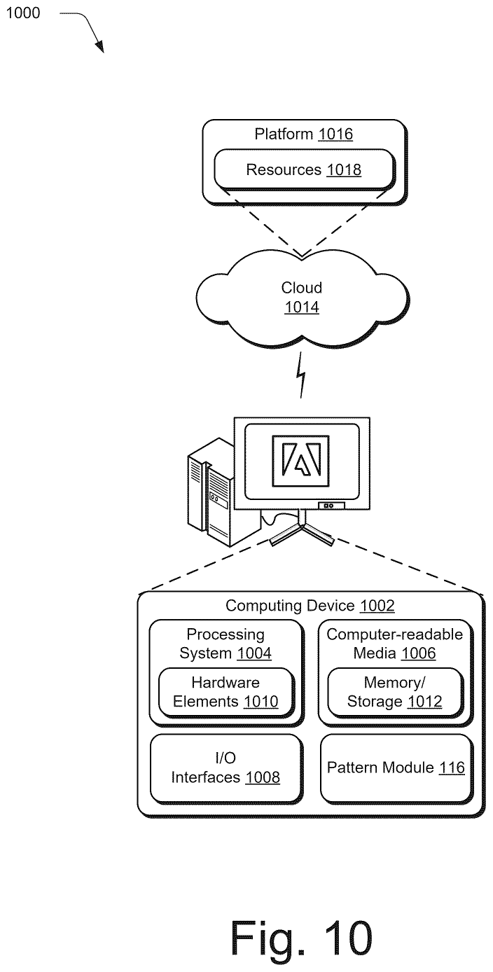

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 10.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a pattern module 116 which is illustrated as incorporated by the image processing system 104 to process the digital content 106. In some examples, the pattern module 116 is separate from the image processing system 104 such as in an example in which the pattern module 116 is available via the network 114.

The pattern module 116 is configured to identify a repeating pattern 118 in a digital image 120. For example, the pattern module 116 first receives an input 122 including the digital image 120. As illustrated in this example, the digital image 120 depicts a textured honeycomb design on a surface. In order to apply the design to other surfaces, for instance, two-dimensional or three-dimensional virtual surfaces, a smaller portion of the digital image 120 that depicts the repeating pattern 118 of the textured honeycomb design is identified. For this reason, a size of a repeating pattern 118 is identified, which corresponds to a portion of the repeating pattern 118 that is capable of application in relations to other surfaces.

To identify the size of the repeating pattern 118, the pattern module 116 generates an autocorrelogram 124 based on the digital image 120. The autocorrelogram 124, for instance, is a one-dimensional graphical representation that illustrates texture variations depicted on the digital image 120. In this example, the autocorrelogram 124 that conveys contrast of pixel color from the digital image 120. Areas of the autocorrelogram 124 with high contrast (e.g., dark pixels relative to light pixels) correspond to a difference between the digital image 120 with itself after shifting a number of pixels equal to the location in the autocorrelogram 124.

The pattern module 116 then extracts a horizontal slice 126 and a vertical slice 128 from the autocorrelogram 124. In this example, the horizontal slice 126 is a horizontal strip of pixels passing through a center of the autocorrelogram 124, and the vertical slice 128 is a vertical strip of pixels passing through the center of the autocorrelogram 124. Based on the slices, the pattern module 116 generates data indicating horizontal pixel values 130 corresponding to the horizontal slice 126 and data indicating vertical pixel values 132 corresponding to the vertical slice 128. In this example, the data indicating the horizontal pixel values 130 corresponding to the horizontal slice 126 and the data indicating the vertical pixel values 132 corresponding to the vertical slice 128 involves one-dimensional frequency waves corresponding to levels of color contrast between pixels of the horizontal slice 126 and pixels of the vertical slice 128.

The pattern module 116 identifies peaks in the data that indicate sizes of repeating patterns (i.e., where a repeating segment of a pattern begins and ends) in the horizontal and vertical directions. A distance between two peaks, for instance, indicates a length of the repeating pattern 118. Based on the peaks, the pattern module 116 identifies a size estimation value of the repeating pattern 118.

In some examples, the pattern module 116 additionally performs a Fourier transform on the data indicating horizontal pixel values 130 corresponding to the horizontal slice 126 and the data indicating vertical pixel values 132 corresponding to the vertical slice 128 to identify an additional size estimation value of the repeating pattern 118. The additional size of the repeating pattern 118, for instance, is determined based on the number repetitions of the repeating pattern 118 in the digital image 120. To do this, the Fourier transform translates locations of the peaks into a frequency that corresponds to the number of repetitions of the repeating pattern 118 by changing a domain of the data indicating the horizontal pixel values 130 corresponding to the horizontal slice 126 and the data indicating the vertical pixel values 132 corresponding to the vertical slice 128. The pattern module 116 then converts the frequency back to a pixel space that provides an additional size estimation value for the repeating pattern 118.

Based on the size estimation value and the additional size estimation value, the pattern module 116 generates an output 134 indicating a size 136 of a portion of the digital image 120 that corresponds to the repeating pattern 118. In this example, the pattern module 116 selects a larger value between the size estimation value and the additional size estimation value. The output 134 is indicated by a height and a width of the repeating pattern 118, measured using pixels in some examples. Because the size 136 of the portion of the digital image 120 that corresponds to the repeating pattern 118 is identified, it is capable of being applied to other surfaces, including two-dimensional or three-dimensional virtual surfaces, by piecing together or repeating the repeating pattern 118 of the textured honeycomb design.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Identifying Repeating Patterns

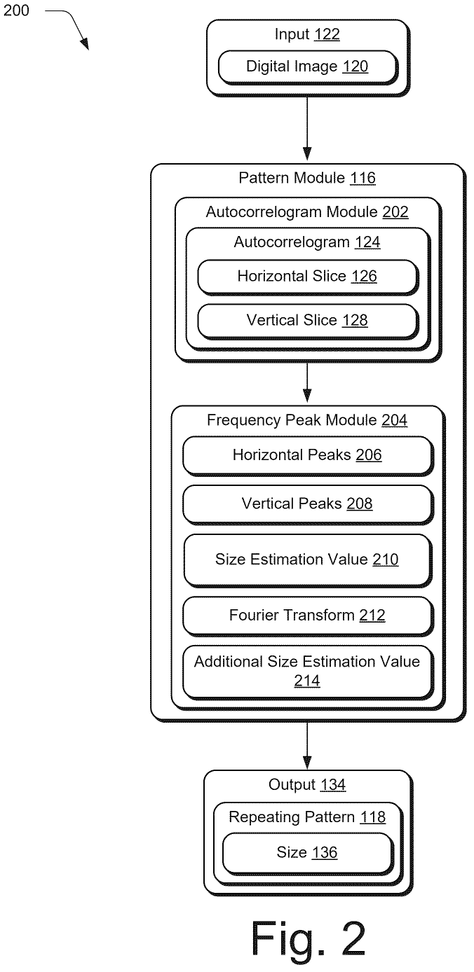

FIG. 2 depicts a system 200 in an example implementation showing operation of the pattern module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-10.

To begin in this example, a pattern module 116 receives an input 122 including a digital image 120. At least a portion of the digital image 120, for instance, includes a repeating pattern, which is intended for extraction and application to another image or surface in this example.

To identify a repeating pattern 118 in the digital image 120, the pattern module 116 includes an autocorrelogram module 202. The autocorrelogram module 202 generates an autocorrelogram 124 based on the digital image 120. For example, the autocorrelogram 124 is a graphical representation that illustrates texture variations depicted on the digital image 120. In some examples, the autocorrelogram 124 is a version of the digital image 120 that conveys contrast of pixel color. Areas of the autocorrelogram 124 with high contrast (e.g., dark pixels relative to light pixels) indicate texture depicted on the digital image 120.

The autocorrelogram module 202 automatically identifies a horizontal slice 126 and a vertical slice 128 from the autocorrelogram 124, or directly from the digital image 120 in some examples. In this example, the horizontal slice 126 is a horizontal strip of pixels passing through a center of the autocorrelogram 124, and the vertical slice 128 is a vertical strip of pixels passing through the center of the autocorrelogram 124.

The pattern module 116 also includes a frequency peak module 204. The frequency peak module is configured to automatically generate data indicating horizontal pixel values 130 corresponding to the horizontal slice 126 and data indicating vertical pixel values 132 corresponding to the vertical slice 128. In this example, the data indicating the horizontal pixel values 130 corresponding to the horizontal slice 126 and the data indicating the vertical pixel values 132 corresponding to the vertical slice 128 involves frequency waves corresponding to levels of color contrast between pixels of the horizontal slice 126 and pixels of the vertical slice 128. The pattern module 116 identifies peaks in the data that indicate sizes of repeating patterns (i.e., where a repeating segment of a pattern begins and ends) in the horizontal and vertical directions. The frequency peak module 204 therefore identifies a size estimation value 210 of the repeating pattern 118 in the digital image 120, based on horizontal peaks 206 and vertical peaks 208 of the autocorrelogram 124.

In some examples, the frequency peak module 204 also performs a Fourier transform 212 on the data indicating horizontal pixel values 130 corresponding to the horizontal slice 126 and the data indicating vertical pixel values 132 corresponding to the vertical slice 128 to generate an additional size estimation value 214. For instance, the Fourier transform 212 results in a frequency change that provides a number of repetitions of the repeating pattern 118 in the digital image 120. The frequency is then changed back to a pixel space, resulting in the additional size estimation value 214. Then, the pattern module 116 selects a maximum of the two sizes (based on the size estimation value 210 or the additional size estimation value 214) as a size 136 of the repeating pattern 118. Additionally, in some examples the pattern module 116 leverages a machine learning model to identify the size estimation value 210 and/or the additional size estimation value 214. For instance, the machine learning model is trained on image or pattern recognition on an autocorrelogram 124.

Based on determining the size 136 of the repeating pattern 118, the pattern module 116 generates an output 134 indicating a portion of the digital image 120 that corresponds to the repeating pattern 118. In some examples, the repeating pattern 118 is then extracted or isolated from the digital image 120 for incorporation into a different image or surface.

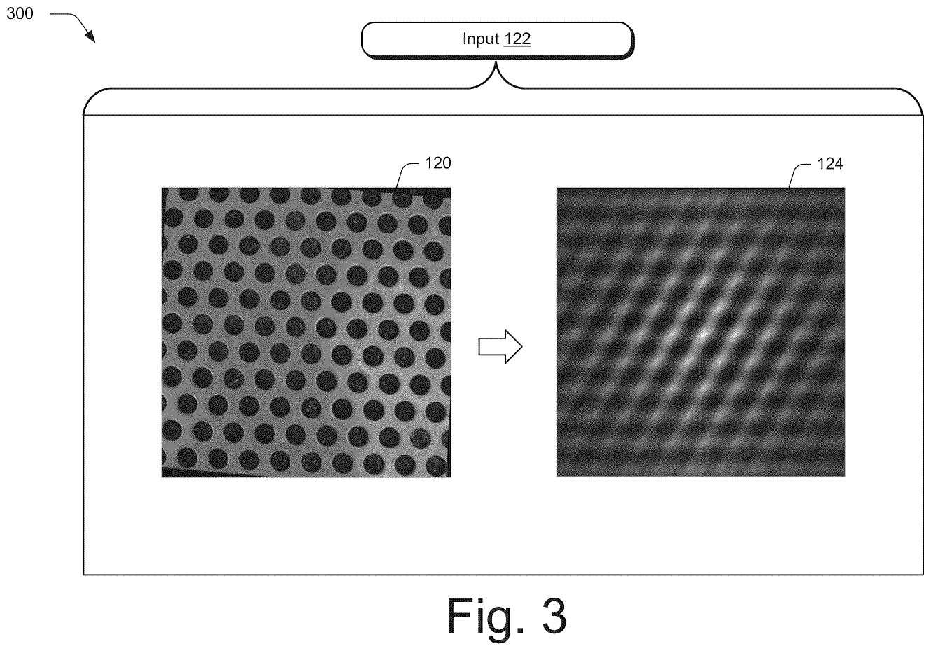

FIGS. 3-7 depict stages of identifying repeating patterns. In some examples, the stages depicted in these figures are performed in a different order than described below.

FIG. 3 depicts an example 300 of receiving an input including a digital image. As illustrated, the pattern module 116 receives an input 122 including a digital image 120. The digital image 120 in this example is a two-dimensional image that depicts a textured honeycomb pattern.

Although this example contemplates a digital image 120 that includes an unobstructed pattern, other examples involve digital images that depict content other than patterns. For example, a pattern is partially obscured, or the digital image 120 includes depicts non-patterned content in addition to the pattern. Other examples of patterned content include geometric patterns, texture patterns, fractal patterns, symmetrical patterns, asymmetrical patterns, Moiré patterns, striped and gridded patterns, dot-based patterns, and repetitive iconic patterns. Geometric patterns feature repeating shapes including squares, circles, and hexagons, while texture patterns mimic natural or artificial surfaces including brick walls, fabric weaves, or tree bark. Fractal patterns exhibit self-replication at different scales, including snowflakes or leaf veins. Moiré patterns emerge from overlapping grids, and are also found in scanned images or digital screens. Striped and gridded patterns include repeating lines, similar to barcodes or woven fabrics, while dot-based patterns include halftone effects in print or polka dots. Additionally, repetitive iconic patterns feature recurring symbols, found in wallpapers or tiled backgrounds.

In this example, I is the digital image 120 of shape (H,W,C), i.e. having C channels each of size H×W pixels. F(I) represents a two-dimensional Fourier transform of I. F(I_{i,:}) and F(I_{I,j}) represent one-dimensional Fourier transforms of row i and column j in I respectively, and F⁻¹(I) is an inverse Fourier transform.

An autocorrelogram module 202 of the pattern module 116 generates an autocorrelogram 124 based on the digital image 120. For example, the autocorrelogram 124 is a graphical representation that illustrates texture variations depicted on the digital image 120. In some examples, the autocorrelogram 124 is a version of the digital image 120 that conveys contrast of pixel color. Areas of the autocorrelogram 124 with high contrast (e.g., dark pixels relative to light pixels) indicate texture depicted on the digital image 120. A(I) is a two-dimensional autocorrelogram of I, which has a shape matching the shape of I, where each pixel A[i,j] represents how much the image I is shifted by i,j in relation to the digital image 120 (i.e., original image) I: A[i,j]=Ĩ_{i,j}·I, where Ĩ_{i,j} is image I circularly padded, shifted by i,j pixels, and cropped back to the shape of I, and · denotes a scalar dot product.

The autocorrelogram 124 is computed with complexity O(n log n) using a Fast Fourier Transform (and its inverse): A(I)=F⁻¹(|F(I)|²), which allows for quickly processing of multiple sizes of digital images. In some examples, the digital image 120 is cropped into a square before computing the autocorrelogram 124, to maximize presence of the pattern at the edges of the autocorrelogram 124 as well as to increase processing speed.

In some examples, the autocorrelogram 124 is also smoothed (for example, by 3-5 pixels) to prevent selecting spurious maxima in the next step, which are false or misleading peaks in a dataset. Additionally, in some examples a decay is applied toward the exterior of the autocorrelogram 124 to avoid maxima far from the origin. This decay is obtained by smoothing the modulus of the Fourier transform before taking the inverse Fourier transform to obtain the autocorrelogram 124.

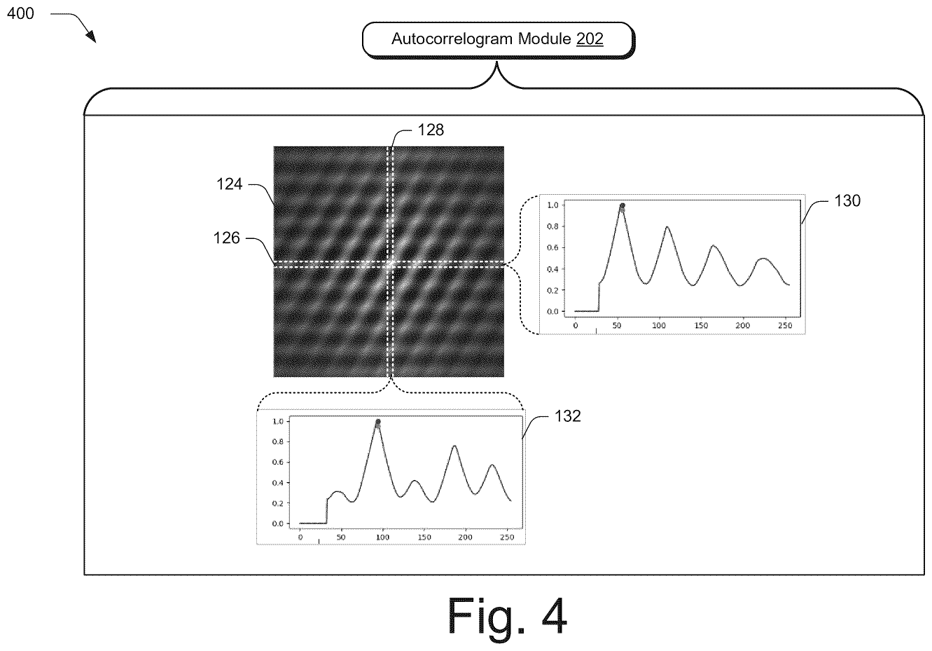

FIG. 4 depicts an example 400 of identifying a horizontal slice of the digital image and a vertical slice of the digital image. FIG. 4 is a continuation of the example described in FIG. 3. After the pattern module 116 receives the input 122 including the digital image 120, the autocorrelogram module 202 identifies a horizontal slice 126 and a vertical slice 128 of the autocorrelogram 124 and generates data describing pixel color along the horizontal slice 126 and the vertical slice 128.

In this example, the autocorrelogram module 202 extracts a horizontal slice 126 and a vertical slice 128 from the autocorrelogram 124, or directly from the digital image 120 in some examples. In this example, the horizontal slice 126 is a horizontal strip of pixels passing through a center of the autocorrelogram 124, and the vertical slice 128 is a vertical strip of pixels passing through the center of the autocorrelogram 124.

The pattern module 116 also includes a frequency peak module 204. The frequency peak module is configured to generate data indicating horizontal pixel values 130 corresponding to the horizontal slice 126 and data indicating vertical pixel values 132 corresponding to the vertical slice 128. In this example, the data indicating the horizontal pixel values 130 corresponding to the horizontal slice 126 and the data indicating the vertical pixel values 132 corresponding to the vertical slice 128 involves frequency waves corresponding to levels of color contrast between pixels of the horizontal slice 126 and pixels of the vertical slice 128. The pattern module 116 identifies peaks in the data that indicate sizes of repeating patterns (i.e., where a repeating segment of a pattern begins and ends) in the horizontal and vertical directions. A distance between horizontal peaks 206, for instance, indicates a length of the repeating pattern 118, and a distance between vertical peaks 208 indicates a height of the repeating pattern 118.

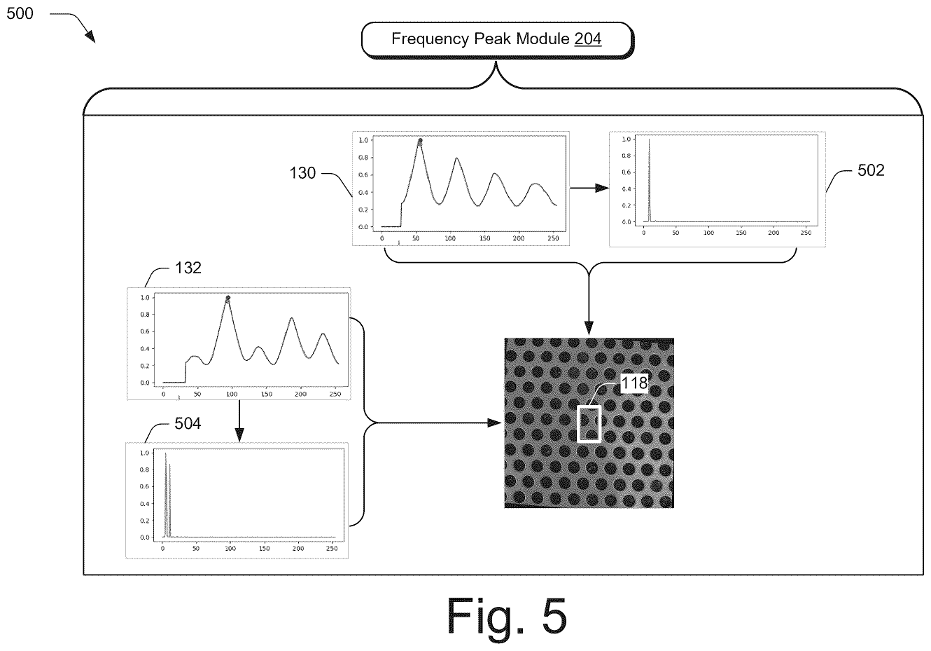

FIG. 5 depicts an example 500 of determining a size of a portion of the digital image depicting a repeating pattern based on pixel color along the horizontal slice of the digital image and pixel color along the vertical slice of the digital image. FIG. 5 is a continuation of the example described in FIG. 4. After the autocorrelogram module 202 identifies the horizontal slice 126 and the vertical slice 128 of the autocorrelogram 124 and generates the data describing the pixel color along the horizontal slice 126 and the vertical slice 128, the frequency peak module 204 determines a size of the repeating pattern 118 in the digital image 120 based on the autocorrelogram 124.

To identify the repeating pattern 118 based on the Fourier transform 212, for a discreet signal of length L, the pattern module 116 identifies a peak at position k from the center, which corresponds to a repeating wavelength of size L/k. Based on this, the pattern module 116 computes a repeating pattern size with the position (f_{H}, f_{W}) (with respect to the center) of a maximum of the autocorrelogram 124, and using p_{H}=H/f_{H} and p_{W}=W/f_{W}. However, because candidate sizes are of the form p=L/k with k as an integer number restricts the values estimated, for instance for L=512 pixels and k=1, 2, 3 etc., the possible candidates are 512, 256, 171 pixels etc., which excludes intermediate values. For this reason, the autocorrelogram module 202 determines the repeating pattern 118 given a Fourier modulus of a slice of the autocorrelogram 124, the slice of the autocorrelogram 124, and a maximum frequency peak at position k in the Fourier modulus. For instance, the autocorrelogram module 202 estimates p=L/k and performs optimization to search the location of the largest value \tilde{p} closest to p, which improves consistency.

By construction, the autocorrelogram 124 includes high contrast values at positions where, if the autocorrelogram 124 were shifted, it would resemble the autocorrelogram 124. Therefore, a value corresponding to a shift is estimated in the form (sₕ, s_{w}) that would preserve the appearance of the autocorrelogram 124, as the shift corresponds to a size of the repeating pattern 118. However, identifying the value corresponding to the shift involves a local maximum search, which is difficult to perform without hyperparameter tuning. A solution to this problem involves dual estimation based on the horizontal slice 126 and the vertical slice 128, which allows to drop hyperparameters by turning one local maximum search problem into multiple global maxima search problems.

In some examples, for instance, two sources of information are considered: the position (p_{H},p_{w}) of a maximum value of the autocorrelogram 124 or the position (f_{H},f_{W}) of a maximum in the modulus of the Fourier transform of the autocorrelogram 124, and using a relationship between a frequency peak and a pattern size. In some examples, using the largest of both values is the relevant estimate for the pattern size.

For instance, the frequency peak module 204 identifies a size estimation value 210 of the repeating pattern 118 in the digital image 120, based on horizontal peaks 206 and vertical peaks 208 of the autocorrelogram 124. The size estimation value 210, for instance, indicates a size in the horizontal direction (e.g., a length) and a size in the vertical direction (e.g., a height) measured in pixels or other units of measurement.

Additionally, in some examples, the frequency peak module 204 performs a Fourier transform 212 on the data indicating horizontal pixel values 130 corresponding to the horizontal slice 126 and the data indicating vertical pixel values 132 corresponding to the vertical slice 128 to identify a number of repetitions of the repeating pattern 118 in the digital image 120, which is used to determine an additional size estimation value 214 of the repeating pattern 118. For instance, the frequency peak module 204 generates translated horizontal data 502 and translated vertical data 504 based on the Fourier transform 212. The coordinates of the maxima in the H slice and W slice correspond respectively the candidate pattern size

$$( {p}_{H}^{i m} , {p}_{W}^{i m} )$$

from the image domain source. The size of the repeating pattern 118 is therefore represented as:

$${p}_{H} = max ( {p}_{H}^{i m} , {p}_{H}^{freq} )$$

$${p}_{W} = max ( {p}_{W}^{i m} , {p}_{W}^{freq} ) .$$

In some examples, the pattern module 116 uses a maximum of both sources to avoid errors.

The additional size estimation value 214 indicates an additional estimate of the size of the repeating pattern 118 in the horizontal and vertical directions. Then, the pattern module 116 selects a maximum of the two sizes (based on the size estimation value 210 or the additional size estimation value 214) as a size 136 of the repeating pattern 118, which is the output 134. In some examples, the repeating pattern 118 is then extracted or isolated from the digital image 120 based on the determined size for incorporation into a different image or surface.

Because the portion of the digital image 120 that corresponds to the repeating pattern 118 is identified, it is capable of being applied to other surfaces, including two-dimensional or three-dimensional virtual surfaces, by piecing together or repeating the repeating pattern 118 of the textured honeycomb design.

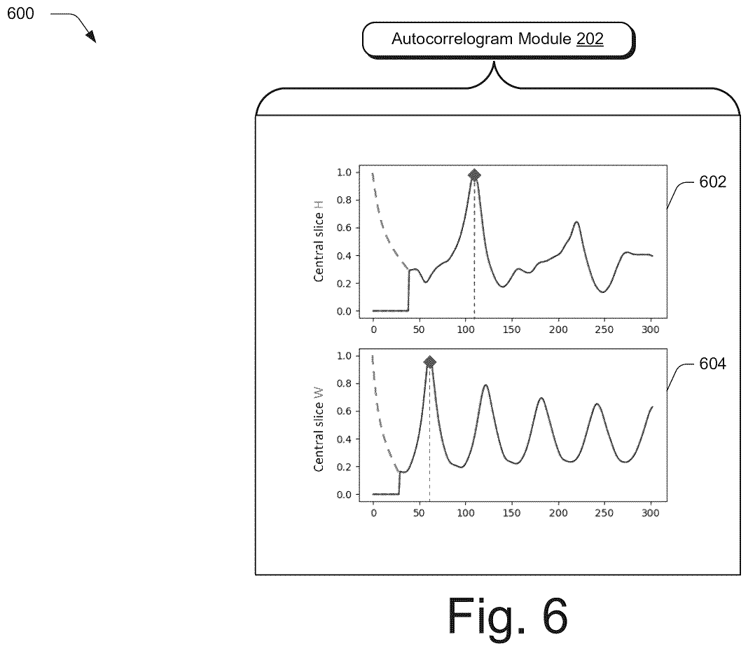

FIG. 6 depicts an example 600 of data from autocorrelograms corresponding to the horizontal slice of the digital image and the vertical slice of the digital image.

In this example, a central peak is removed, corresponding to a global maximum, which is not informative. This is because the central peak is split in half and therefore does not result in a repeating pattern when shifted. To remove the central peak, the pattern module 116 starts from the center and removes values outward until the signal ceases to decrease.

As shown in this example, the horizontal slice 126 and the vertical slice 128 are plotted. The central peak is removed, and the remaining global maximum represents the size of the repeating pattern 118. Accordingly, the pattern module 116 generates a cropped vertical slice 602 and a cropped horizontal slice 604, which have the central peak removed.

The central slices, with the central peak removed, represent a space to search for a global maximum, as discussed in relation to FIG. 5. The coordinates of the maxima in the H slice and W slice correspond respectively to the candidate pattern size

$$( {p}_{H}^{i m} , {p}_{W}^{i m} )$$

from the autocorrelogram 124.

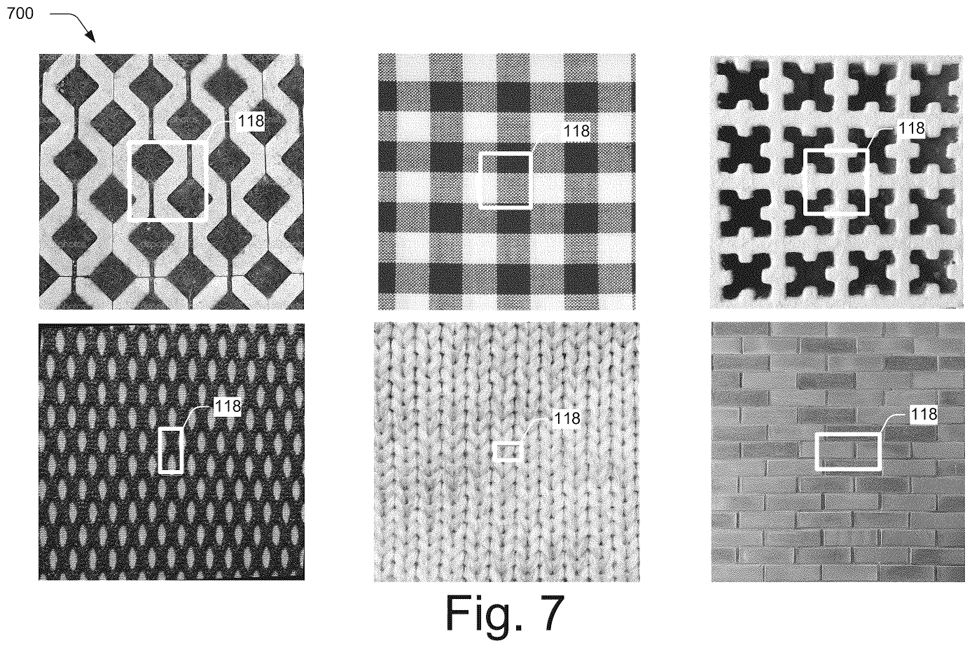

FIG. 7 depicts an example 700 of outputs from identifying repeating patterns. As illustrated, the techniques described herein for identifying repeating patterns are applicable to a variety of type of repeating patterns present in different materials that are depicted in digital images. These include, but are not limited to, repeating patterns present in fabric, tile, strong, brick, wallpaper, wood, metal, or other materials.

Conventional repeating pattern identification techniques perform iterative operations on multiple candidate sections of digital images, which is slow and uses a large amount of resources to fine-tune selections of the repeating pattern. In contrast, the techniques described herein for identifying repeating patterns involve measuring color contrast between pixels along the horizontal slice 126 and the vertical slice 128 of the autocorrelogram 124 of the digital image 120 to identify the repeating pattern 118. This identifies repeating patterns more quickly by avoiding performing operations on multiple candidate operations or fine-tuning selections of the repeating pattern, compared to the conventional repeating pattern identification techniques.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-10.

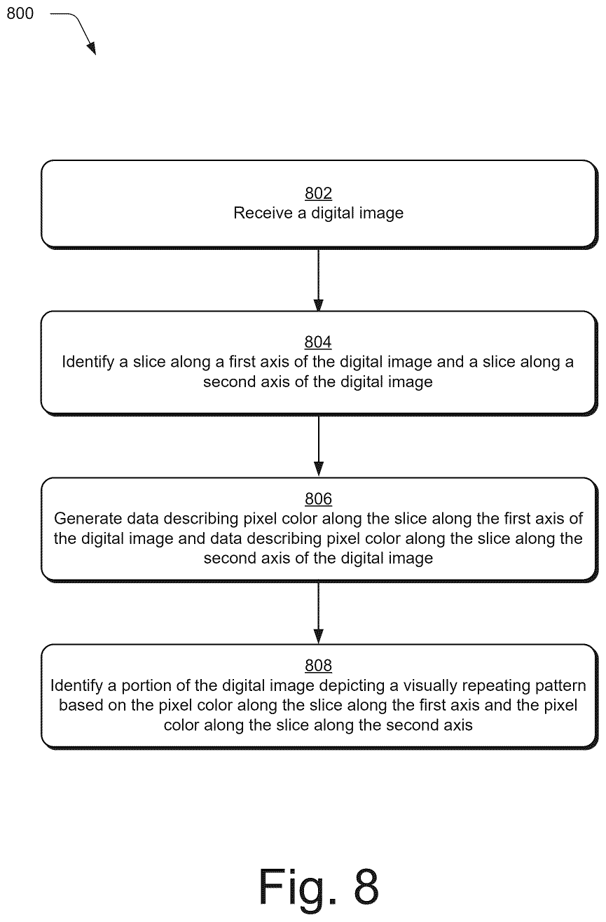

FIG. 8 depicts a procedure 800 in an example implementation of identifying repeating patterns. At block 802 a digital image 120 is received. For example, the digital image 120 is a two-dimensional image that depicts a surface of a patterned object or composition of materials.

At block 804, a slice along a first axis of the digital image 120 and a slice along a second axis of the digital image 120 are identified. For example, the first axis and the second axis are perpendicular to each other. Some examples further comprise generating a two-dimensional autocorrelogram describing depicted texture variations on the digital image 120 for identifying the slice along the first axis of the digital image 120 and the slice along the second axis of the digital image 120. For example, the slice along the first axis of the digital image 120 and the slice along the second axis of the digital image 120 pass through a center of the digital image 120.

At block 806, data describing pixel color along the slice along the first axis of the digital image 120 and data describing pixel color along the slice along the second axis of the digital image 120 are generated. For example, the data describing the pixel color along the slice along the first axis of the digital image 120 and the data describing the pixel color along the slice along the second axis of the digital image 120 includes a graph depicting peaks that correlate to sizes of repeating patterns. Some examples further comprise generating a signal identifying maximum color contrast between pixels by performing a Fourier transform 212 on the data describing the pixel color along the slice along the first axis of the digital image 120 and the data describing the pixel color along the slice along the second axis of the digital image 120.

At block 808, a portion of the digital image depicting a visually repeating pattern is identified based on the pixel color along the slice along the first axis and the pixel color along the slice along the second axis. Some examples further comprise applying the portion of the digital image 120 depicting the visually repeating pattern to cover a three-dimensional virtual object. In some examples, the peaks correspond to sizes of repeating patterns. Some examples further comprise offsetting the portion of the digital image 120 depicting the visually repeating pattern based on the peaks. Some examples further comprise identifying a height and a width of the portion of the digital image depicting the visually repeating pattern.

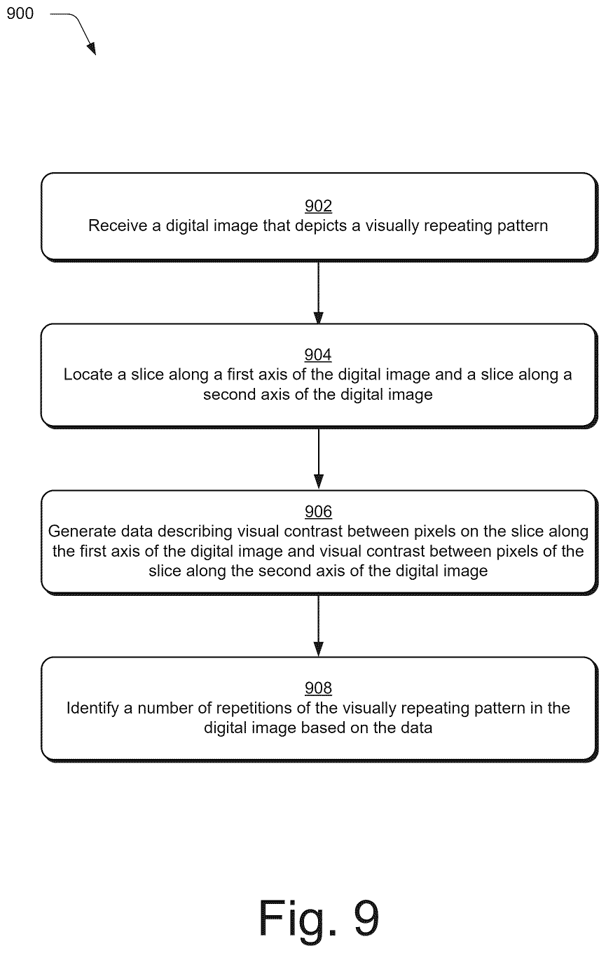

FIG. 9 depicts a procedure 900 in an additional example implementation of identifying repeating patterns. At block 902, a digital image 120 is received that depicts a visually repeating pattern.

At block 904, a slice along a first axis of the digital image 120 and a slice along a second axis of the digital image 120 are located. For example, the slice along the first axis of the digital image 120 and the slice along the second axis of the digital image 120 pass through a center of the digital image 120.

At block 906, data describing visual contrast between pixels on the slice along a first axis of the digital image 120 and visual contrast between pixels of the slice along the second axis of the digital image 120 are generated. Some examples further comprise generating a two-dimensional autocorrelogram describing depicted texture variations on the digital image 120 for identifying the slice along a first axis of the digital image 120 and the slice along the second axis of the digital image 120. For example, the data describing the visual contrast between the pixels on the slice along a first axis of the digital image 120 and the visual contrast between the pixels of the slice along the second axis of the digital image 120 includes a graph depicting peaks that correlate to sizes of repeating patterns. Some examples are further configured to generate a signal identifying maximum color contrast between the pixels by performing a Fourier transform 212 on the data describing the data describing the visual contrast between the pixels on the slice along a first axis of the digital image 120 and the visual contrast between the pixels of the slice along the second axis of the digital image 120.

At block 908, a number of repetitions of the visually repeating pattern is identified based on the data. Some examples further comprise applying a portion of the digital image 120 depicting the visually repeating pattern to cover a three-dimensional virtual object. In some examples, the number of repetitions correspond to a size of the visually repeating pattern.

### Example System and Device

FIG. 10 illustrates an example system generally at 1000 that includes an example computing device 1002 that is representative of one or more computing systems and/or devices that implement the various techniques described herein. This is illustrated through inclusion of the pattern module 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices and/or processing systems 1004) to implement techniques, modules, and examples described herein.

The techniques described herein are supported by various configurations of the computing device 1002 and are not limited to the specific examples of the techniques described herein. This functionality is also implementable through use of a distributed system, such as over a “cloud” 1114 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized when computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

What is claimed is:

1. A method comprising:
receiving, by a processing device, a digital image;
identifying, by the processing device, a slice along a first axis of the digital image and a slice along a second axis of the digital image;
generating, by the processing device, data describing pixel color along the slice along the first axis of the digital image and data describing pixel color along the slice along the second axis of the digital image; and
identifying, by the processing device, a portion of the digital image depicting a visually repeating pattern based on the pixel color along the slice along the first axis and the pixel color along the slice along the second axis.

2. The method of claim 1, further comprising applying the portion of the digital image depicting the visually repeating pattern to cover a three-dimensional virtual object.

3. The method of claim 1, wherein the first axis and the second axis are perpendicular to each other.

4. The method of claim 1, further comprising generating a two-dimensional autocorrelogram describing depicted texture variations on the digital image for identifying the slice along the first axis of the digital image and the slice along the second axis of the digital image.

5. The method of claim 1, wherein the data describing the pixel color along the slice along the first axis of the digital image and the data describing the pixel color along the slice along the second axis of the digital image includes a graph depicting peaks.

6. The method of claim 5, wherein the peaks correspond to a size of the visually repeating pattern in the digital image.

7. The method of claim 5, further comprising offsetting the portion of the digital image depicting the visually repeating pattern based on locations of the peaks.

8. The method of claim 1, further comprising generating a signal identifying maximum color contrast between pixels by performing a Fourier transform on the data describing the pixel color along the slice along the first axis of the digital image and the data describing the pixel color along the slice along the second axis of the digital image.

9. The method of claim 1, further comprising identifying a height and a width of the portion of the digital image depicting the visually repeating pattern.

10. A non-transitory computer-readable storage medium storing executable instructions, which when executed by a processing device, cause the processing device to perform operations comprising:
receiving a digital image that depicts a visually repeating pattern;
locating a slice along a first axis of the digital image and a slice along a second axis of the digital image;
generating data describing visual contrast between pixels on the slice along the first axis of the digital image and visual contrast between pixels of the slice along the second axis of the digital image; and
identifying a number of repetitions of the visually repeating pattern in the digital image based on the data.

11. The non-transitory computer-readable storage medium of claim 10, further configured to perform operations comprising applying a portion of the digital image depicting the visually repeating pattern to cover a three-dimensional virtual object.

12. The non-transitory computer-readable storage medium of claim 10, further configured to perform operations comprising generating a two-dimensional autocorrelogram describing depicted texture variations on the digital image for identifying the slice along the first axis of the digital image and the slice along the second axis of the digital image.

13. The non-transitory computer-readable storage medium of claim 10, wherein the data describing the visual contrast between the pixels on the slice along the first axis of the digital image and the visual contrast between the pixels of the slice along the second axis of the digital image includes a graph depicting peaks.

14. The non-transitory computer-readable storage medium of claim 13, wherein the peaks correspond to a size of the visually repeating pattern.

15. The non-transitory computer-readable storage medium of claim 10, further configured to perform operations comprising generating a signal identifying maximum color contrast between the pixels by performing a Fourier transform on the data describing the data describing the visual contrast between the pixels on the slice along the first axis of the digital image and the visual contrast between the pixels of the slice along the second axis of the digital image.

16. The non-transitory computer-readable storage medium of claim 10, wherein the slice along the first axis of the digital image and the slice along the second axis of the digital image pass through a center of the digital image.

17. A system comprising:
means for receiving a digital image;
means for identifying a slice along a first axis of the digital image and a slice along a second axis of the digital image;
means for generating data describing pixel color along the slice along the first axis of the digital image and data describing pixel color along the slice along the second axis of the digital image; and
means for identifying a portion of the digital image depicting a visually repeating pattern based on the pixel color along the slice along the first axis and the pixel color along the slice along the second axis.

18. The system of claim 17, further comprising applying the portion of the digital image depicting the visually repeating pattern to cover a three-dimensional virtual object.

19. The system of claim 17, wherein the data describing the pixel color along the slice along the first axis of the digital image and the data describing the pixel color along the slice along the second axis of the digital image includes a graph depicting peaks that correlate a size of the visually repeating pattern.

20. The system of claim 19, further comprising generating a signal identifying maximum color contrast between pixels by performing a Fourier transform on the data describing the pixel color along the slice along the first axis of the digital image and the data describing the pixel color along the slice along the second axis of the digital image.
